(19) United States
(12) Patent Application Publication
(10) Pub. No.: US 2007/0164160 A1
(43) Pub. Date: Jul. 19, 2007

(54) Support device for fire-detection system

(75) Inventors: Denis Guillois, Limours (FR); Yannick Lamy, Meudon (FR)

Correspondence Address: OLIFF & BERRIDGE, PLC, P.O. BOX 19928, ALEXANDRIA, VA, 22320, US

(73) Assignee: Aircelle, Gonfreville L'Orcher (FR)

(21) Appl. No.: 10/581,746

(22) PCT Filed: Nov. 29, 2004
(86) PCT No.: PCT/FR04/03051

§ 371 Date: Jun. 6, 2006

(30) Foreign Application Priority Data
Dec. 11, 2003 (FR) 0314509

(51) Int. Cl. B64D 47/00

(52) U.S. Cl. 244/129.2

(57) ABSTRACT

The invention relates to a support device which is designed to be installed between an aircraft engine and an associated thrust reverser, said device being equipped with a support means which can support at least one fire-detection element in the form of a capillary. The invention is characterized in that the support means comprises at least two retaining members which can be removably assembled to one another.

The present invention relates to a support device designed to be installed between an aircraft engine and an associated thrust reverser, this device being provided with a means of support capable of supporting at least one fire-detection component produced in the form of a capillary.

It is prior art to use fire-detection systems to report a fire affecting one of the engines of the aircraft as soon as possible. In all cases, each fire-detection system comprises on the one hand a support device attached to a fixed part, and on the other hand at least one fire-detection component produced in the form of a capillary, the latter being supported by a means of support incorporated in the support device. The support device varies from one fire-detection system to another depending on whether it is designed to be attached to a fixed part of the engine assembly or to a fixed part of the thrust reverser positioned around the engine assembly.

If the support device is fixed to the engine, the means of support consist of a metal collar capable of withstanding the high temperature that occurs within the enclosure. This type of attachment may however be found to be unsatisfactory because the capillary can be damaged by the rubbing of the collar.

If the support device is fixed to the thrust reverser, the means of support may either by a collar or a PTFE ring with a connecting slot. However, if the collar is metallic, a further problem arises in that the part of the collar that comes into contact with the detecting components acts as a thermal ridge capable not only of damaging the structure of the thrust reverser but also of causing errors in said detecting components. Moreover, a problem with the PTFE ring, which cannot be used if the detecting system is positioned on the engine owing to its poor heat resistance, is that it does not necessarily keep the detecting component in position under all the circumstances as the detecting component may accidentally come out of the connecting slot through which it was previously inserted.

It is an object of the present invention to counter the problems cited above, for which purpose it consists in a support device designed to be installed between an aircraft engine and an associated thrust reverser, this device being provided with a means of support capable of supporting at least one fire-detection component produced in the form of a capillary, said device being characterized in that the means of support comprises at least two holding members capable of being assembled to each other detachably.

Thus, in a support device according to the invention the holding members can grip each capillary and prevent its accidental removal. Furthermore, depending on the location of the fire-detection system, a material suitable for the means of support can be selected. Thus, if the fire-detection system is to be installed on the engine, the holding members can be made of metal to withstand the ambient temperature. If on the other hand such a fire-detection system is to be installed on the thrust reverser, the holding members will preferably be made of a material with a low density and low thermal conductivity in order to avoid the creation of thermal bridges that could not only damage components of the thrust reverser that are made of composite material but also cause errors in the detecting components.

The means of support advantageously comprises two holding members each made in the form of a half-cylindrical body. Also advantageously, each body has a flat face provided with at least one longitudinal furrow in which a fire-detection capillary can be placed.

Each body preferably has a side wall in which longitudinal recesses are formed, each of which latter can be enclosed by two end shoulders.

In a preferred embodiment of the invention, the support device comprises at least two metal shells that can be arranged around the holding members. This is especially advantageous if the holding members are made from a material that is a poor heat conductor and liable to deteriorate in the event of a fire. Should this happen, the two metal shells form a rigid mold within which the holding members and the detecting components are confined. Since moreover these shells are never in contact with the detecting components, there is no possibility of a thermal bridge being created. Advantageously, each shell is made in the form of a part capable of fitting around part of the exterior of the holding members. A support device of this kind also preferably comprises a clip holder capable of being positioned at least partially around the shells, each of which may comprise at least one slot into which the clip holder can be partially inserted.

A support device according to the invention advantageously comprises a spring clip in which the holder members or, if appropriate, the assembly consisting of the holding members and the shells, can be engaged. Advantageously again, the spring clip rests on an intermediate mount that bears on an anchor plate. If this support device is installed on the thrust reverser, and more particularly if the latter has a composite structure, a heat-insulating blanket is laid between the spring clip and the intermediate mount. This heat-insulating blanket may in fact be one of those which are traditionally fixed to the inside surfaces of the panels of the thrust reverser. The spring clip is in addition preferably attached to the anchor plate by a cable passing through the intermediate mount.

A clearer understanding of the invention will be gained from the detailed description set out below with reference to the attached drawing, in which:

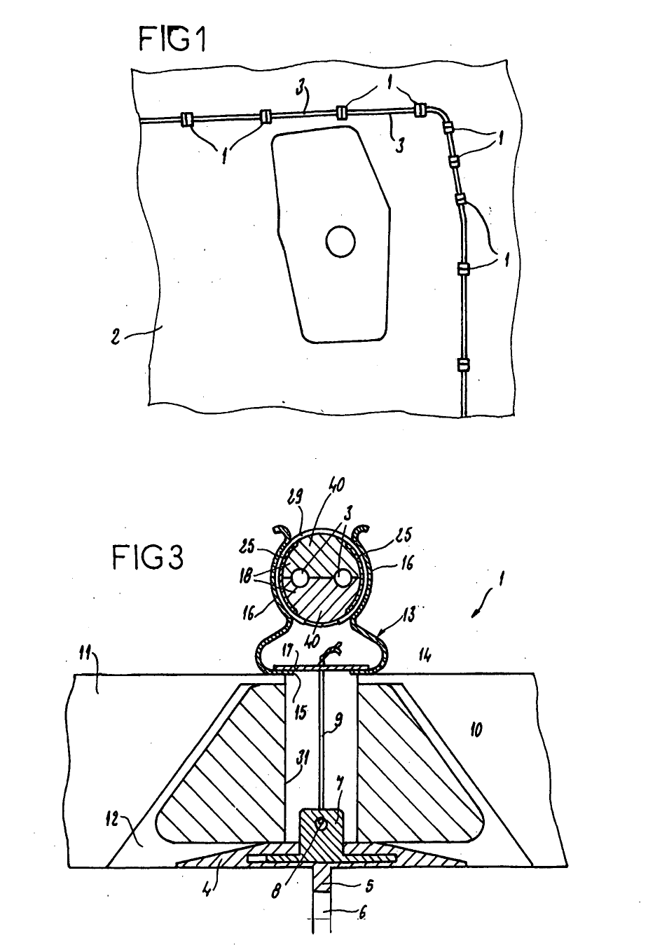

FIG. 1 is a partial view of a thrust reverser panel to which are fixed several support devices according to the invention, connected to each other by the detecting components;

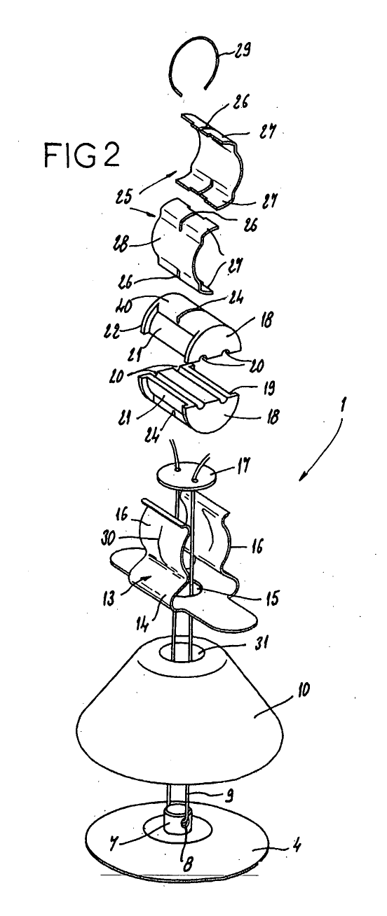

FIG. 2 is an exploded perspective view of a support device according to the invention;

FIG. 3 is a cross section passing through the clip holder of the support device shown in FIG. 2;

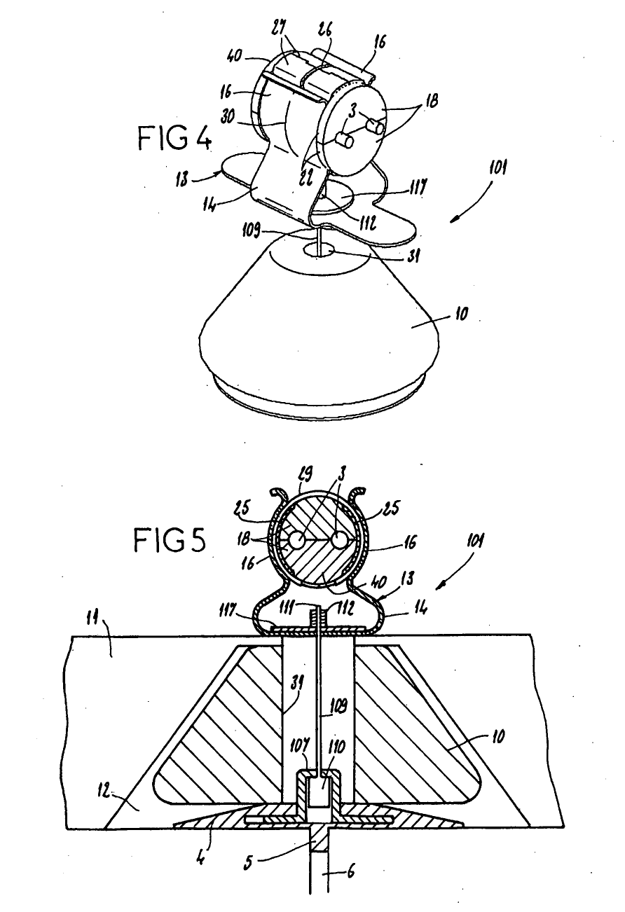

FIG. 4 is a perspective view of another support device in accordance with the preferred embodiment of the invention, but omitting the heat-insulating blanket and the anchor plate; and

FIG. 5 is a cross section passing through the clip holder of the support device shown in FIG. 4.

As shown in FIG. 1, a fire-detection system mounted upon the thrust reverser comprises, on the one hand, support devices 1 spaced apart and fixed in a panel 2 of said thrust reverser, and, on the other hand, two detecting components each consisting of a capillary 3. A panel 2 of this kind is usually made of a composite material.

More specifically, a support device 1 according to the invention, as shown in FIGS. 2 and 3, is formed from an anchor plate 4 fixed for example by adhesive bonding to the thrust reverser panel 2. This anchor plate 4 possesses both a central stud 7 pointing towards the engine, a bore 8 passing through this central stud 7, and a locating pin 5 pointing in the opposite direction to the central stud 7 and designed to be inserted into a recess 6 formed in the panel 2.

A wire 9 having two free ends is then inserted through the bore 8 of the central stud 7 of the anchor plate 4. An intermediate mount 10, having a central channel 31 through which the two free ends of the wire 9 are passed, is placed on top of said anchor plate 4. The intermediate mount 10, which may for example be made of compressed metallic felt, or of silicone, is in the general shape of a truncated cone with a circular base. More precisely, this intermediate mount 10 is positioned in such a way as to present only a minimal surface area to the hot source consisting of the engine (not shown), the result of which is to reduce the transfer of heat from the hot source to the cold source, the latter being the panel 2 of the thrust reverser.

A heat-insulating blanket 11 is then laid over the intermediate mount 10. More precisely, the latter is housed in a recess 12 in the blanket 11, which is complementary to said intermediate mount 10.

A spring clip 13, which has a base 14 containing a central hole 15 and two circular-section elastic side arms 16, is then placed on the heat-insulating blanket 11 and can be secured to the latter by for example welding, snap-fastening or riveting. A washer 17 containing two orifices is then placed over the hole 15 of the base 14. Each of the two free ends of the wire 9 is then fed through the hole 15 in the spring clip 13 and through one of the orifices of the washer 17, and finally the two free ends are twisted together so that the heat-insulating blanket 11 and the intermediate mount 10 are compressed against the panel 2 by the action of the washer 17 and the base 14 of the spring clip 13.

A support device 1 of this kind also includes a means of support made from two identical holding members 18 each in the form of a half-cylindrical body. Each of these bodies 18 has both a flat face 19 containing two longitudinal parallel furrows 20, and a side wall of circular section in which there are recessed two opposing longitudinal recesses 21 defining two humps 40. These recesses 21 are of circular section and are each enclosed by two end shoulders 22, while a central transverse groove 24 runs through each of the humps 40.

Consequently, when it is wished to attach the capillaries 3 to the support device 1, the first step is to lay each capillary 3 in the corresponding furrow 20 of one body 18. The second body 18 is then placed on top of the first, each furrow 20 of the first body 18 being designed to form a channel with the corresponding furrow 20 of the second body 18. When thus brought together, the two bodies 18 define a cylinder, around part of which two metal shells 25 can be placed.

Each of these shells 25 is approximately the same length as the recesses 21; includes two central transverse slots 26; and is complementary in general shape to said cylinder. More precisely, each shell 25 has two extreme edges 27 situated either side of a central circular-section part 28 that is to come into contact with part of the side wall of the cylinder represented by two adjoining recesses 21, one on the first and one on the second body 18. These shells 25 can then be secured to the cylinder by a clip holder 29 placed around said shells 25 and designed to sit in the slots 26 of the shells 25 and in at least the groove 24 of one of the bodies 18. The capillaries 3 are now trapped inside the bodies 18 and shells 25, and the resulting assembly can finally be pushed into place between the two arms 16 of the spring clip 13, said arms 16 being designed to embrace said shells 25. As shown more particularly in FIG. 2, each arm 16 includes a slight concavity 30 in which the clip holder 29 is housed. When thus positioned, the cylinder is prevented from being moved translationally by the two end shoulders 22 enclosing the arms 16 of the spring clip 13.

This kind of support device 1 therefore includes a means of support realized by two holding members assembled to each detachably, since, simply by first pushing apart the two arms 16 of the spring clip 13 and then extracting the clip holder 29, the two bodies 18 can be separated from each other.

Another support device 101 in accordance with the preferred embodiment of the invention is shown in FIGS. 4 and 5. Components common to both support devices 1 and 101 retain the same reference numbers. However, in this support device 101, a metal cable 109 replaces the wire 9 attaching the spring clip 13 to the anchor plate 4. This cable 109 has on the one hand a first enlarged end 110 trapped in a recess formed in a central stud 107 connected to the anchor plate 4, and on the other hand a second end 111 which is inserted through the single orifice of the washer 117. Last of all a ring 112 is crimped onto said second end 111, this ring 112 having a cross section greater than the opening of the orifice of the washer 117.

Although the invention has been described in connection with particular illustrative embodiments, it will be obvious that it is not limited to these in any way and that it encompasses all technical equivalents of the means described, and combinations of these, where these come within the scope of the invention.

1. A support device designed to be installed between an aircraft engine and an associated thrust reverser, this device being provided with a means of support capable of supporting at least one fire-detection component produced in the form of a capillary, wherein the means of support comprises at least two holding members capable of being assembled to each other detachably.

2. The support device as claimed in claim 1, wherein the means of support comprises two holding members each made in the form of a half-cylindrical body.

3. The support device as claimed in claim 2, wherein each body has a flat face provided with at least one longitudinal furrow in which a fire-detection capillary can be placed.

4. The support device as claimed in claim 2, wherein each body has a side wall in which longitudinal recesses are formed.

5. The support device as claimed in claim 4, wherein each longitudinal recess is enclosed by two end shoulders.

6. The support device as claimed in claim 1, wherein it comprises at least two metal shells that can be arranged around the holding members.

7. The support device as claimed in claim 6, wherein each shell is made in the form of a part capable of fitting around part of the exterior of the holding members.

8. The support device as claimed in claim 6, wherein it comprises a clip holder capable of being positioned at least partially around the shells.

9. The support device as claimed in claim 8, wherein each shell comprises at least one slot into which the clip holder can be partially inserted.

10. The support device according to claim 1, wherein it comprises a spring clip in which the holder members can be engaged.

11. The support device as claimed in claim 10, wherein the spring clip rests on an intermediate mount that bears on an anchor plate.

12. The support device as claimed in claim 11, wherein the spring clip is attached to the anchor plate by a cable passing through the intermediate mount.
